(19) United States
(12) Patent Application Publication
(10) Pub. No.: US 2026/0115958 A1
(43) Pub. Date: Apr. 30, 2026

(54) HANDLING DEVICE AND METHOD FOR REMOVING A RESIDUAL GRID ASSEMBLY

(71) Applicant: TRUMPF Werkzeugmaschinen SE + Co. KG, Ditzingen (DE)

(72) Inventor: Stefan Krause, Wilthen (DE)

(21) Appl. No.: 19/430,394

(22) Filed: Dec. 23, 2025

Related U.S. Application Data
(63) Continuation of application No. PCT/EP2024/068419, filed on Jun. 30, 2024.

(30) Foreign Application Priority Data
Jun. 30, 2023 (DE) 10 2023 117 368.5

(51) Int. Cl. B26D 7/18; B23K 26/70

(52) U.S. Cl. CPC B26D 7/18; B23K 26/702

(57) ABSTRACT

A handling device for removing a residual grid assembly from a workpiece support in a machine tool, the residual grid assembly being configured to be produced from a plate-shaped material by a cutting process and including at least one workpiece and a residual grid which are arranged in a common workpiece plane after machining, the handling device including a support framework, a rear-engagement device, and a holding down element. The rear-engagement device has rear-engagement elements which can be moved relative to the support framework and, in an engagement position, jointly engage behind the at least one workpiece and the residual grid. The holding-down element is provided on the support framework. The holding-down element is provided between the support framework and the rear-engagement elements arranged in the engagement position. The residual grid assembly is configured to be clamped in position between the holding-down element and the rear-engagement elements.

### CROSS REFERENCE TO RELATED APPLICATIONS

This application is a continuation of International Application No. PCT/EP2024/068419 (WO 2025/003509 A1), filed on Jun. 30, 2024, and claims benefit to German Patent Application No. DE 10 2023 117 368.5, filed on Jun. 30, 2023. The aforementioned applications are hereby incorporated by reference herein.

### FIELD

The invention relates to a handling device for removing a residual grid assembly from a workpiece support in a machine tool and to a method for removing the residual grid assembly from the workpiece support in the machine tool.

### BACKGROUND

EP 2 177 293 A1 discloses a method for removing a workpiece from a residual grid which is produced by cutting a plate-shaped material. It is provided that a suction element is positioned above the workpiece to be removed. Subsequently, a part of the workpiece support is lifted up simultaneously with the suction element such that the workpiece located therebetween is lifted relative to the residual grid. The workpiece removed from the residual grid is then transferred to an unloading station using the suction element. Each cut workpiece is thus removed individually from the residual grid.

Furthermore, EP 2 662 182 B1 discloses a method and a device for removing a residual grid assembly from a workpiece support in a machine tool with subsequent separation of the workpieces from a residual grid. This device comprises a support framework on which a rear-engagement device is provided, which comprises rake-like rear-engagement elements which can be moved relative to the support framework. To remove the residual grid assembly, the device is positioned with an open rear-engagement device toward the workpiece support such that the rake-like rear-engagement elements can be positioned between support webs of the workpiece support in order to engage an underside of the residual grid assembly. The residual grid assembly resting on the rear-engagement elements is then lifted up from the workpiece support. The residual grid assembly is then lifted up from the holding elements such that the workpiece parts can fall out of the residual grid. Particularly in the case of a residual grid assembly in which the workpieces are completely cut free from the residual grid, the workpieces may tilt relative to the residual grid when the residual grid assembly is lifted from the workpiece support, such that subsequent separation of the workpieces may be more difficult.

### SUMMARY

In an embodiment, the present disclosure provides a handling device for removing a residual grid assembly from a workpiece support in a machine tool, the residual grid assembly being configured to be produced from a plate-shaped material by a cutting process and comprising at least one workpiece and a residual grid which are arranged in a common workpiece plane after machining, the handling device comprising a support framework, a rear-engagement device, and a holding down element. The rear-engagement device is provided on the support framework, the rear-engagement device having rear-engagement elements which can be moved relative to the support framework and, in an engagement position, jointly engage behind the at least one workpiece and the residual grid. The holding-down element is provided on the support framework. The holding-down element is provided between the support framework and the rear-engagement elements arranged in the engagement position. The residual grid assembly is configured to be clamped in position between the holding-down element and the rear-engagement elements arranged in the engagement position.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a machine arrangement for laser cutting plate-shaped workpieces with a laser cutting machine and an automation unit arranged in front of it with a handling device;

FIG. 2 illustrates a schematic side view of the handling device above a workpiece support;

FIG. 3 illustrates a schematic side view of the workpiece support with a residual grid assembly placed thereon, corresponding to section A-A in FIG. 2;

FIG. 4 illustrates a schematic side view of the handling device in an arrangement resting on the residual grid assembly;

FIG. 5 illustrates a schematic side view of the handling device in an engagement position for the residual grid assembly;

FIG. 6 illustrates a further schematic side view of the handling device in the engagement position according to FIG. 5, corresponding to section B-B in FIG. 5; and

FIG. 7 illustrates a schematic side view of the handling device with the residual grid assembly in a lifted-up position relative to the workpiece support.

### DETAILED DESCRIPTION

In an embodiment, the present disclosure provides a handling device and a method for removing a residual grid assembly from a workpiece support in a machine tool in order to achieve increased process reliability for an automated removal of a residual grid assembly.

The foregoing is achieved by a handling device with a support framework on which a rear-engagement device with rear-engagement elements is provided, in which a holding-down element is provided on the support framework, which holding-down element is arranged between the support framework and the rear-engagement elements arranged in an engagement position, such that, for removing the residual grid assembly from the workpiece support in the machine tool, the residual grid assembly is held clamped between the holding-down element and the rear-engagement elements. The holding-down element, which is positioned above and resting on the residual grid assembly for removing the residual grid assembly, can counteract tilting of the at least one workpiece relative to the residual grid. This allows the at least one workpiece and the residual grid to remain aligned in a common plane or workpiece plane of the residual grid assembly during removal. This enables reliable and controlled removal of the residual grid assembly from the workpiece support, thereby increasing process reliability for automation.

It is preferably provided that the holding-down element and/or the rear-engagement elements is and/or are adjustable in height relative to the support framework. Alternatively or additionally, the holding-down element and/or the rear-engagement elements can be adjustable in their spacing from one another. This enables simple and quick adaptation to the thickness of the plate-shaped material from which the residual grid assembly is produced by cutting the workpiece.

Furthermore, it is preferably provided that the holding-down element is positioned resiliently relative to the support framework. This enables at least a small holding force between the holding-down element and the rear-engagement elements to securely hold the residual grid assembly. In addition, it can be provided that, for example, the holding-down element is positioned in a spring-loaded manner on the residual grid element relative to the support framework in order to subsequently move the rear-engagement elements into an engagement position such that, during subsequent lifting, a clamping force remains between the holding-down element and the rear-engagement elements in order to reliably remove the residual grid assembly from the workpiece support.

The holding-down element is advantageously aligned parallel to the rear-engagement elements. This allows a uniform clamping force to be achieved over the entire surface of the residual grid assembly.

The holding-down element in particular takes the form of a holding-down plate which extends over the entire surface. This allows the holding-down element to rest over the entire format of the residual grid assembly. In particular, it is provided that the holding-down element is provided in a format which is the same size as or slightly larger than the format of the residual grid assembly.

Holding elements are preferably provided on the support framework of the handling device, by way of which holding elements the holding-down element is detachably and/or replaceably received. This makes it easy to select and use different formats for the holding-down element.

The residual grid assembly can comprise at least one workpiece in a residual grid or in a plurality of residual grid portions. At least one workpiece can be completely cut free from the residual grid. Alternatively, it can also be provided that at least one web connection, in particular as a microjoint or nanojoint, is provided between the at least one workpiece and the residual grid.

Advantages of embodiments of the present disclosure are further achieved by a method for removing a residual grid assembly from a workpiece support in a machine tool, in which the handling device is advanced from above with an open position or a disengaged position of the rear-engagement elements on the residual grid assembly and in which a holding-down element arranged on the support framework is positioned above the residual grid assembly and in which the rear-engagement elements are moved into an engagement position and in which the residual grid assembly is held clamped between the holding-down element and the rear-engagement elements, such that the residual grid assembly is then lifted up from the workpiece support. This method for removing the residual grid assembly has the advantage that when the residual grid assembly is lifted, tilting of the at least one workpiece relative to the residual grid is prevented. The holding-down element can counteract any tilting or jamming of the at least one workpiece in the residual grid and the at least one workpiece remains aligned in the plane of the residual grid. This can increase process reliability during removal.

Furthermore, it is preferably provided that the support framework of the handling device with a holding-down element arranged thereon is advanced onto the residual grid assembly until the holding-down element rests on the residual grid assembly and subsequently the rear-engagement elements are moved into the engagement position. This means that the at least one workpiece in the residual grid can already be secured in its position before the rear-engagement elements are moved into the engagement position for engaging behind or under the residual grid assembly.

An embodiment of the method provides that the holding-down element is advanced onto the residual grid assembly and, once it is resting on the residual grid assembly, is retracted along a spring travel path relative to the support framework. This has the advantage that a defined clamping effect can be set between the holding-down element and the rear-engagement elements in order to enable reliable removal of the residual grid assembly.

Furthermore, it is preferably provided that the residual grid assembly and the holding-down element resting thereon are transferred together into a separating device in which the at least one workpiece is separated from the residual grid. This combined transfer of the residual grid assembly with the holding-down element resting thereon into the separating device has the advantage that the at least one workpiece is guided out of the residual grid or exclusively separated out downward, thus enabling purposeful separation of the at least one workpiece from the residual grid.

Embodiments and developments of the present disclosure are described and explained in more detail below with reference to the examples illustrated in the drawings. The features that can be derived from the description and the drawings can be applied according to the present disclosure individually or in any combination together.

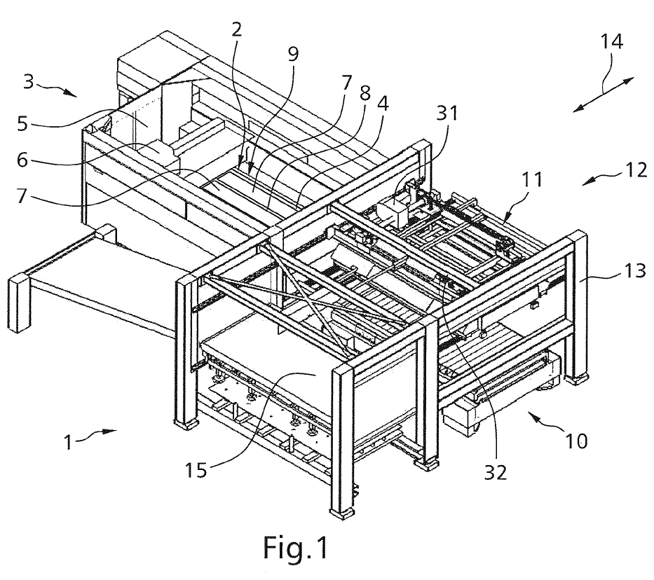

FIG. 1 shows a perspective view of a machine arrangement 1 with a machine tool 3, in which a plate-shaped material 2 is separated by being cut by a cutting device into at least one workpiece 7 and a residual grid 8 or a plurality of residual grids. The machine tool 3 preferably takes the form of a laser cutting machine.

For cutting processing, the plate-shaped material 2, in particular the metal sheet, is arranged on a workpiece support 15 in the interior of a working zone 5 of the machine tool 3. In a known manner, the plate-shaped material 2 is passed over by a laser cutting head 6 of the laser cutting machine for cutting processing. FIG. 1 shows a plate-shaped material 2 inside the working zone after the cutting processing, during which workpiece blanks or workpieces 7 in the form of finished parts and a residual grid 8 at least partially surrounding the workpiece 7 have been produced as processing products. There is a cutting gap of a few millimeters wide between the workpiece 7 and the residual grid 8. The at least one cut workpiece 7 and the residual grid 8 form a residual grid assembly 9. It is preferably provided that the at least one workpiece 7 is completely cut free from the residual grid 8. Alternatively, it can also be provided that the workpiece 7 is connected and held in the residual grid 8 by at least one web portion, in particular a microjoint or nanojoint.

The workpiece support 15 is provided on a movable pallet 4, which was moved with the plate-shaped material 2 through a slot-shaped opening in a housing of the machine tool 3 into its working zone 5. Previously, the workpiece support 15 with the raw plate-shaped material 2 was placed on the front side of the machine tool 3 on a conventional pallet changer 10. On the pallet changer 10, the pallet 4 with the workpiece support 15 is moved back after the processing of the plate-shaped material 2 with the residual grid assembly 9 resting thereon. From the pallet changer 10, the residual grid assembly 9 is jointly removed by a handling device 11 of an automation unit 12.

The handling device 11 is motor-driven and can be moved on a linear device 13 of the automation unit 12 in the direction of a double-headed arrow 14. The handling device 11 can be moved either via the pallet changer 10 or via a workpiece support 15 arranged laterally next to the pallet changer 10. In addition, in the example shown, the handling device 11 can approach a pallet 4 on which unprocessed plate-shaped material 2 is stored.

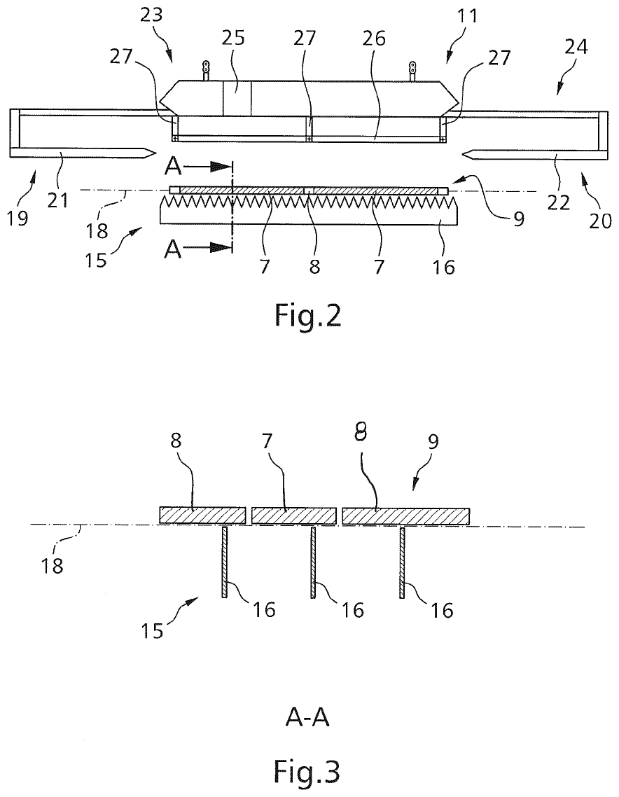

In FIG. 1, the pallet 4 with the residual grid assembly 9 is still located inside the working zone 5 of the machine tool 3. Once the pallet 4 and the residual grid assembly 9 resting thereon have been transferred to the pallet changer 10, the conditions shown schematically in FIG. 2 are obtained.

FIG. 2 shows a schematic side view of the workpiece support 15. This workpiece support 15 comprises or consists of a plurality of support slats 16 arranged one behind the other. These support slats 16 are advantageously aligned parallel to each other at a predetermined spacing from one another. The residual grid assembly 9 is placed on tips of the support slats 16. This is shown schematically in a further side view according to FIG. 3. The at least one workpiece 7 and the residual grid 8 of the residual grid assembly 9 lie in a horizontal workpiece plane 18, which is indicated by dash-dotted lines in FIGS. 2 and 3.

The handling device 11 is moved into a position above the pallet changer 10 or the pallet 4. Rear-engagement elements 19, 20 are arranged movably on a support framework 23 of the handling device 11. These rear-engagement elements 19, 20 preferably take the form of a rake and have rake tines 21, 22 arranged one behind the other with interspaces perpendicular to the plane of the drawing in FIG. 2. The rear-engagement elements 19, 20 are positioned in an open position or a disengaged position relative to the support framework 23 according to FIG. 2. Together, the rake-like rear-engagement elements 19, 20 form a rear-engagement device 24 of the handling device 11. A schematically illustrated rake drive 25 on the support framework 23 serves to move the rake-like rear-engagement elements 19, 20.

A holding-down element 26 is provided on the support framework 23 of the handling device 11. This holding-down element 26 is positioned at a distance from the support framework 23. Advantageously, at least one holding element 27 is provided on the support framework 23. This holding element 27 receives the holding-down element 26 in a detachable, in particular replaceable, manner. The holding-down element 26 can take the form of a holding-down plate. The holding-down element 26 can be made in one piece or from a plurality of portions which are, however, arranged to lie in a common plane to the support framework 23. The holding elements 27 can be spring-mounted on the support framework 23. This enables the holding-down element 26 to perform a relative movement in the direction of the support framework 23. The spring bearing is configured such that the holding-down element 26, in an arrangement of the handling device 11 according to FIG. 2, is spaced apart from the residual grid assembly 9 at a predetermined or maximum distance from the support framework 23.

The handling device 11 in the entirety shown in FIG. 2 can be moved up and down or displaced in the vertical direction relative to the pallet changer 10 or to the pallet 4 by way of a drive motor 31 shown in FIG. 1. FIG. 1 also shows a chassis 32 of the handling device 11, which chassis supports the support framework 23 with its attachments in a height-adjustable manner and which in turn can be moved by a motor on the linear unit 13 of the automation unit 12.

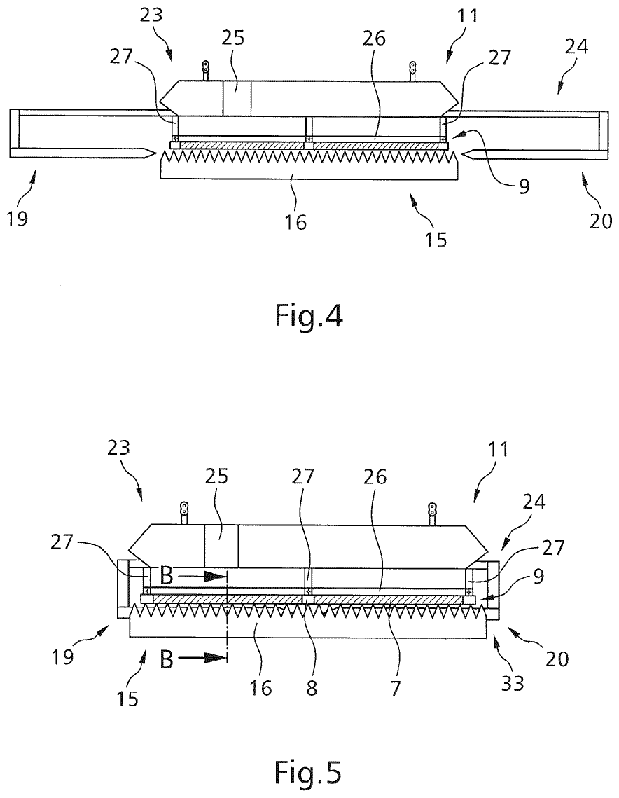

To remove the residual grid assembly 9, the handling device 11 with the opened rear-engagement elements 19, 20 is lowered into the position shown in FIG. 4. The holding-down element 26 is advanced from above onto the residual grid assembly 9. The lowering movement is preferably continued until the holding-down element 26 is positioned at least resting on the residual grid assembly 9. Preferably, it can be provided that the holding-down element 26 is positioned to rest with a contact force on the residual grid assembly 9. In this case, being spring-mounted, the holding-down element 26 is retracted in the direction of the support framework 23 along a predetermined spring travel path.

Once the holding-down element 26 is resting on the residual grid assembly 9, the rear-engagement elements 19, 20 are positioned at a level slightly below the underside of the residual grid assembly 9.

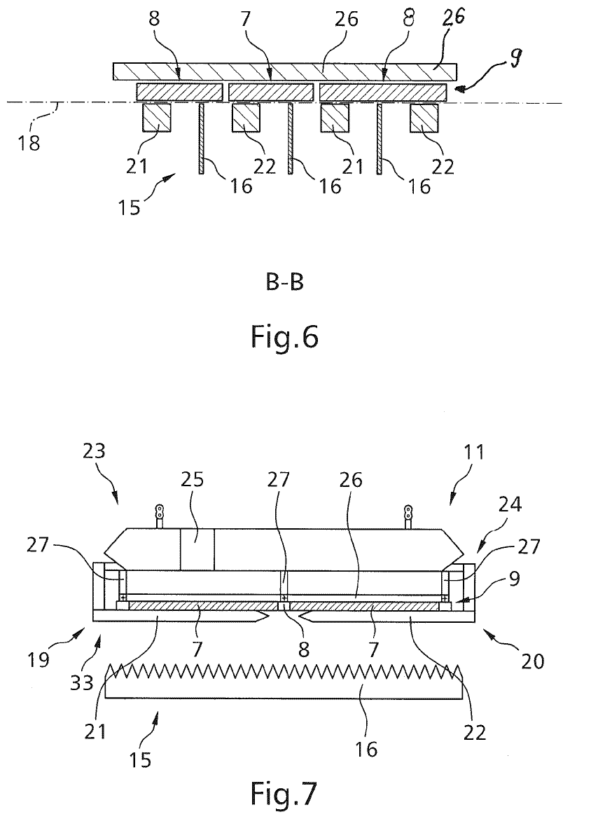

Starting from the position of the handling device 11 shown in FIG. 4, the rear-engagement elements 19, 20 are moved toward each other by way of the rake drive 25 and transferred into an engagement position 33. This is illustrated in FIG. 5. In the engagement position 33 of the rear-engagement elements 19, 20, the residual grid assembly 9 is positioned between the rake tines 21, 22 on the one hand and the holding-down element 26 on the other hand. The positioning of the residual grid assembly 9 between the holding-down element 26 and the rear-engagement elements 19, 20 is shown schematically in a further simplified side view according to FIG. 6. It is apparent therefrom that tilting of the at least one workpiece 7 toward the residual grid 8 is prevented.

Subsequently, the handling device 11 is moved upward by way of the lifting drive motor 31. In a first lifting phase, the rear-engagement elements 19, 20 engage on an underside of the residual grid assembly 9. Thanks to the holding-down element 26, which is preferably arranged with a retracted spring travel path, this holding-down element 26 remains held in contact with the upper side of the residual grid assembly 9 during the first lifting phase, such that the residual grid assembly 9 is then held clamped between the holding-down element 26 and the rear-engagement elements 19, 20. As can be seen from the side view according to FIG. 6, this enables both the residual grid 8 and the at least one workpiece 7 of the residual grid assembly 9 to remain aligned in a defined position relative to the holding-down element 26. Tilting of the at least one workpiece 7 relative to the residual grid 8 can thereby be prevented.

In this position of the residual grid assembly 9, which is held clamped between the holding-down element 26 and the rear-engagement elements 19, 20, the residual grid assembly 9 can be securely lifted or removed from the workpiece support 15. FIG. 7 shows the handling device 11 with the residual grid assembly 9 lifted up from the workpiece support 15. The residual grid assembly 9 is held between the holding-down element 26 and the rear-engagement elements 19, 20 or the rake tines 21, 22, as shown in FIG. 6.

The residual grid assembly 9 lifted up from the workpiece support 15 is advanced by way of the handling device 11 to a separating device. The residual grid assembly 9 and the holding-down element 26 resting thereon are transferred together as a unit into the separating device. Subsequently, the at least one workpiece 7 is separated from the residual grid 8 and purposefully only separated out downward.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A handling device for removing a residual grid assembly from a workpiece support in a machine tool, the residual grid assembly being configured to be produced from a plate-shaped material by a cutting process and comprising at least one workpiece and a residual grid which are arranged in a common workpiece plane after machining, the handling device comprising:
a support framework;
a rear-engagement device provided on the support framework, the rear-engagement device having rear-engagement elements which can be moved relative to the support framework and, in an engagement position, jointly engage behind the at least one workpiece and the residual grid;
a holding-down element provided on the support framework;
wherein the holding-down element is provided between the support framework and the rear-engagement elements arranged in the engagement position, and
wherein the residual grid assembly is configured to be clamped in position between the holding-down element and the rear-engagement elements arranged in the engagement position.

2. The handling device according to claim 1, wherein the holding-down element and/or the rear-engagement elements are configured to be adjustable in height relative to the support framework and/or in their spacing from one another.

3. The handling device according to claim 1, wherein the holding-down element is arranged resiliently to the support framework.

4. The handling device according to claim 1, wherein the holding-down element is aligned parallel to the rear-engagement elements.

5. The handling device according to claim 1, wherein the holding-down element takes a form of at least one holding-down plate.

6. The handling device according to claim 1, wherein the holding-down element extends over an entire format of the residual grid assembly.

7. The handling device according to claim 1, wherein holding elements are provided on the support framework, by which holding elements the holding-down element is arranged detachably and/or replaceably on the support framework.

8. The handling device according to claim 1, wherein the residual grid assembly comprises at least one workpiece which is at least partially surrounded by the residual grid, and wherein the at least one workpiece is completely cut free from the residual grid, or wherein the at least one workpiece is connected to the residual grid by at least one web connection.

9. A method for removing a residual grid assembly from a workpiece support in a machine tool, the residual grid assembly being produced by cutting a plate-shaped material positioned on the workpiece support and comprising at least one workpiece and a residual grid which are arranged in a common workpiece plane after machining, the method comprising:
jointly engaging the residual grid assembly behind by the rear-engagement device of the handling device according to claim 1, wherein the rear-engagement device with rear-engagement elements is moved relative to the support framework of the handling device between an open position and the engagement position;
advancing the handling device from above with the open position of the rear-engagement elements onto the residual grid assembly to be removed;
positioning the holding-down element arranged on the support framework above the residual grid assembly;
moving the rear-engagement elements into the engagement position below the residual grid assembly; and
clamping and holding the residual grid assembly by the holding-down element and the rear-engagement elements, and subsequently lifting up the residual grid assembly from the workpiece support.

10. The method according to claim 9, wherein the support framework of the handling device with the holding-down element arranged thereon is advanced onto the residual grid assembly until the holding-down element rests on the residual grid assembly and subsequently the rear-engagement elements are moved into the engagement position.

11. The method according to claim 9, wherein the holding-down element is advanced onto the residual grid assembly and, once the holding-down element is resting on the residual grid assembly, the holding-down element is retracted relative to the support framework along a spring travel path.

12. The method according to claim 9, wherein the residual grid assembly and the holding-down element resting thereon are transferred together into a separating device for separating the at least one workpiece from the residual grid.

13. The handling device according to claim 6, wherein the holding-down element comprises a format which corresponds to or is larger than the format of the residual grid assembly.
